(19) United States
(12) Patent Application Publication
(10) Pub. No.: US 2012/0253886 A1
(43) Pub. Date: Oct. 4, 2012

(54) Systems and Methods for Client Development

(75) Inventors: Jill Aileen Nelson, Moorestown, NJ (US); Norman Edward Mullock, Swedesboro, NJ (US); Kris Satkunas, Richmond, VA (US)

(73) Assignee: LEXISNEXIS, A DIVISION OF REED ELSEVIER INC., Miamisburg, OH (US)

(21) Appl. No.: 13/073,061

(22) Filed: Mar. 28, 2011

(51) Int. Cl. G06Q 10/00

(52) U.S. Cl. 705/7.31

(57) ABSTRACT

Included are systems and methods for client development. Some embodiments may include receiving a client roster for an entity, the client roster including a plurality of clients, receiving client billing data for the plurality of clients, and computing billing trend data for the plurality of clients. Similarly, some embodiments are further configured to generate a user interface for display that provides the billing trend data according to a plurality of fields. The user interface may include a filtering user option to alter the user interface by filtering at least one of the plurality of fields and a report option to generate a report that comprises at least a portion of the billing trend data. Similarly, some embodiments are configured to generate the report in response to selection of the report option and alter the report in response to selection of the filtering user option.

### BACKGROUND

1. Field

Embodiments provided herein generally relate to systems and methods for client development, and particularly to determining client statistics and predictions from a plurality of sources.

2. Technical Background

Client generation and retention is a primary focus for many law firms and other businesses. In a competitive market, attorneys and law firms are judged not only on their legal competence, but on their client roster as well. As such, many law firms target clients who appear to have a need for the services that that law firm can provide. Additionally, many law firms aim to retain current clients as long as possible and increase the work performed for those clients. While client development and retention are of great importance to law firms, oftentimes these law firms have no mechanism to determine their best clients and clients that could provide more work to the law firm. Similarly, the law firms generally have no way of targeting potential clients that could provide work to the law firm in areas where the law firm has room to grow.

### SUMMARY

In one embodiment, a system for client development may include a memory component that stores client analysis logic and client development logic, the client development logic causing the system to receive a client roster for an entity, the client roster including a plurality of clients, receive client billing data for the plurality of clients, and compute billing trend data for the plurality of clients. Similarly, some embodiments are further configured to generate a user interface for display that provides the billing trend data according to a plurality of fields. The user interface may include a filtering user option to alter the user interface by filtering at least one of the plurality of fields and a report option to generate a report that comprises at least a portion of the billing trend data. Similarly, some embodiments are configured to generate the report in response to selection of the report option and alter the report in response to selection of the filtering user option.

In another embodiment, a method for client development may include receiving client identification data for a client, the client identification data being received from client analysis logic, receiving client billing data for the client, and determining from the client identification data and the client billing data, billing trend data for the client. Still some embodiments may include predicting, from the billing trend data, a likelihood of expanded billing for the client and providing, by a computing device, a first user interface for display, the first user interface providing at least a portion of the billing trend data and data related to the likelihood of expanded billing for the client, the first user interface further providing a filtering user option to filter at least a portion of the billing trend data from the first user interface.

In yet another embodiment, a non-transitory computer-readable medium for client development may include a program that when executed by a computer, causes the computer to receive client identification data for a client, the client identification data being received from the client analysis logic, receive client billing data for the client, and determine, from the client identification data and the client billing data, billing trend data for the client. In some embodiments, the program may cause the computing device to determine a potential client trend for a potential client, determine, from the potential client trend, whether the potential client can overcome a deficiency in the client, and provide a user interface for display, the user interface including data related to whether the potential client can overcome the deficiency in the client. Additionally, the user interface may provide a report option to generate a user-configurable report that comprises at least a portion of the client billing data, the user interface providing a filtering user option to at least a portion of the user-configurable report.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a computing environment for client development, according to one or more embodiments shown and described herein;

FIG. 2 depicts a user computing device for providing client development services, according to one or more embodiments shown and described herein;

FIG. 3 depicts a user interface for providing a plurality of client development applications, according to one or more embodiments shown and described herein;

FIG. 4 depicts a user interface for providing statistics on current clients of a law firm, according on one or more embodiments shown and described herein;

FIG. 5 depicts a user interface for filtering client data according to area of law, according on one or more embodiments shown and described herein;

FIG. 6 depicts a user interface for filtering client data organized by year, according on one or more embodiments shown and described herein;

FIG. 7 depicts a user interface for providing a chart of client hours organized by year, according on one or more embodiments shown and described herein;

FIG. 8 depicts a user interface for providing client classifications, according on one or more embodiments shown and described herein;

FIG. 9 depicts a user interface for organizing clients by a profile, according on one or more embodiments shown and described herein;

FIG. 10 depicts a user interface for providing financial metrics of clients, according on one or more embodiments shown and described herein;

FIG. 11 depicts a user interface for providing competitive data about a plurality of clients, according on one or more embodiments shown and described herein;

FIG. 12 depicts a user interface for providing relationship data about a plurality of clients, according on one or more embodiments shown and described herein;

FIG. 13 depicts a user interface for providing exporting options of client data, according on one or more embodiments shown and described herein;

FIG. 14 depicts a process for determining potential expanded billing for a client, according to one or more embodiments shown and described herein;

FIG. 15 depicts a process for determining a client development strategy, according to one or more embodiments shown and described herein;

FIG. 16 depicts a process for determining a strategy for realizing client growth potential, according to one or more embodiments shown and described herein;

FIG. 17 depicts a process for determining a client deficiency, according to one or more embodiments shown and described herein;

FIG. 18 depicts a process for determining a potential client to fill a law firm deficiency, according to one or more embodiments shown and described herein; and

FIG. 19 depicts a process for determining an area that a client could fill a firm deficiency, according to one or more embodiments shown and described herein.

### DETAILED DESCRIPTION

Embodiments disclosed herein include systems and methods for client development. In some embodiments, data related to an existing client may be retrieved and/or determined. Additionally, the client data may be utilized to predict an area where that client may be able to provide additional work and/or provide potential clients who may be able to provide work in areas where the firm is low on work. In so doing, some embodiments may access firm billing data for the client and calculate at least one trend of the client. Similarly, some embodiments may be configured to access sources that are external to the law firm network to determine other potential clients who may have work in areas of need for the law firm. This determination may additionally include a determination of areas of need in the law firm, as well as a determination of contacts that attorneys in the firm have with those clients and potential clients. These and other embodiments are described in more detail below with reference to the drawings.

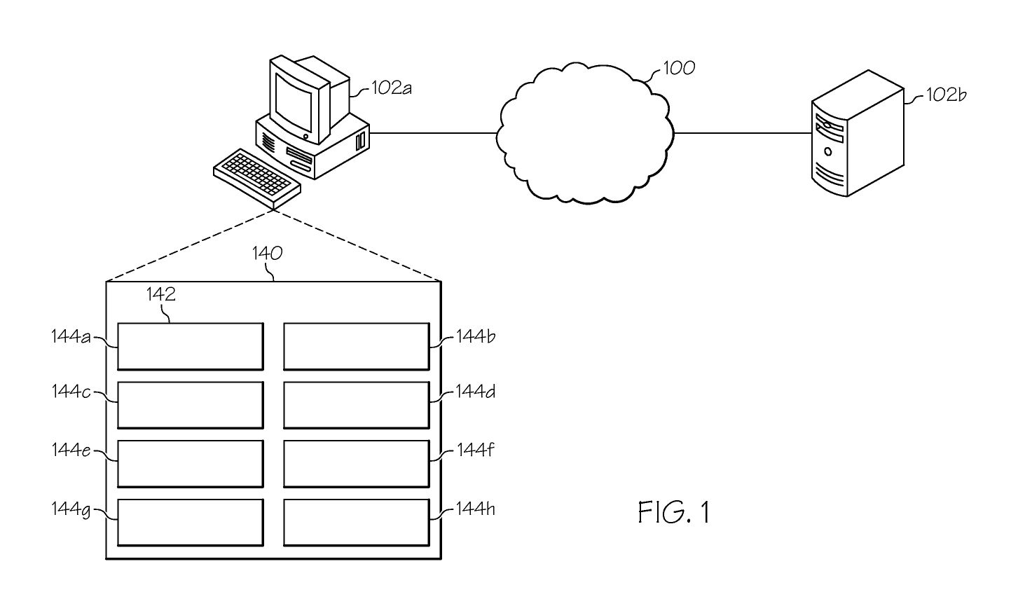

Referring now to the drawings, FIG. 1 depicts a computing environment for client development, according to one or more embodiments shown and described herein. As illustrated, a network 100 may be coupled to a user computing device 102a and a remote computing device 102b. The network 100 may include a wide area network and/or a local area network and thus may be wired and/or wireless. The user computing device 102a may be a computer at a law firm or other entity and may include any portable and/or non-portable computing devices, such as personal computers, laptop computers, personal digital assistants (PDAs), mobile phones, etc. The user computing device 102a may represent one or a plurality of computing devices coupled to a local area network, such as a business network.

Similarly, the remote computing device 102b may include a server and/or other computing device for providing information to the user computing device 102a. In some embodiments, the remote computing device 102b may be configured to provide an online research tool, such as a legal research website, individual research tool, business tool, etc. In some embodiments the remote computing device 102b may include the client analysis logic 144b, contacts logic 144c, etc. for providing remote access to the related functionality. Similarly, in some embodiments, the remote computing device 102b may represent a web server that provides access to other sources, such as those for providing data regarding potential clients.

As discussed in more detail below, the user computing device 102a may include a memory component 140 that stores client development logic 144a, client analysis logic 144b, contacts logic 144c, billing logic 144d, general ledger (GL) logic 144e, budget logic 144f, human resources (HR) logic 144g, and spreadsheet logic 144h to provide the described functionality. The client development logic 144a may include software, hardware, and/or firmware for providing client development prediction capabilities to users, such as at the user computing device 102a. The client analysis logic 144b may include software, hardware, and/or firmware for performing calculations on client data, as may be retrieved from the billing logic 144d, GL logic 1443, budget logic 144f, HR logic 144g, and spreadsheet logic 144h. The contacts logic 144c may include software, hardware, and/or firmware for receiving, storing, and providing contact information for members of a business, such as a law firm. As an example, a first user may have a contact in their electronic contact list, which is imported into the contacts logic 144c. The contacts logic 144c may then provide the first user's contacts to other users authenticated with the contacts logic 144c. The billing logic 144d may include software, hardware, and/or firmware for providing accounting services to the law firm. As such, the billing logic 144d may track payments, accounts receivable, etc. related to the firm clients. The GL logic 144e may similarly include software, hardware, and/or firmware for providing general ledger accounting services of the firm as a whole. The HR logic 144g may include software, hardware, and/or firmware for managing personnel, including billing by attorneys. The spreadsheet logic 144h may include software, hardware, and/or firmware for creating and/or editing data in a spreadsheet.

It should be understood that while the user computing device 102a and the remote computing device 102b are represented in FIG. 1 each as a single component, this is merely an example. In some embodiments, there may be numerous different components that provide the described functionality. More specifically, in some embodiments, the various pieces of logic 144a-144h may be distributed among a plurality of different computing devices, such as those connected to a law firm local area network. However, for illustration purposes, single components are shown in FIG. 1 and described herein.

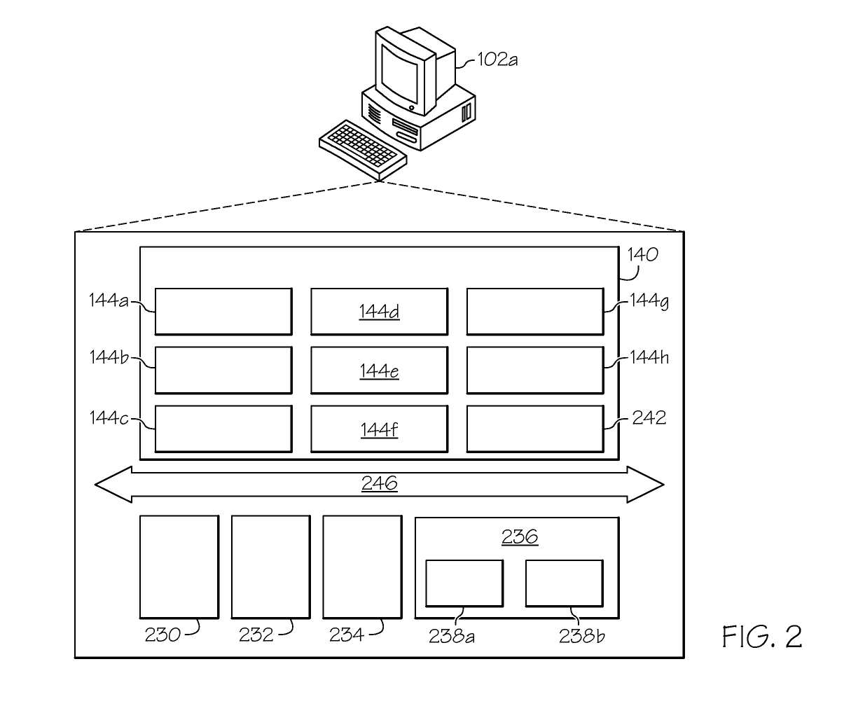

FIG. 2 depicts the user computing device 102a for providing client development services, according to one or more embodiments shown and described herein. In the illustrated embodiment, the user computing device 102a includes a processor 230, input/output hardware 232, network interface hardware 234, a data storage component 236 (which stores legal client data 238a, contact data 238b, and/or other data), and the memory component 140. The memory component 140 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the user computing device 102a and/or external to the user computing device 102a.

Additionally, the memory component 140 may store operating logic 242, the client development logic 144a, the client analysis logic 144b, the contacts logic 144c, the billing logic 144d, the GL logic 144e, the budget logic 144f, the HR logic 144g, and the spreadsheet logic 144h. Each of these components may include a plurality of different pieces of logic, each of which may be embodied as a computer program, firmware, and/or hardware, as an example. A local interface 246 is also included in FIG. 2 and may be implemented as a bus or other interface to facilitate communication among the components of the user computing device 102a.

The processor 230 may include any processing component operable to receive and execute instructions (such as from the data storage component 236 and/or the memory component 140). The input/output hardware 232 may include and/or be configured to interface with a monitor, positioning system, keyboard, mouse, printer, image capture device, microphone, speaker, gyroscope, compass, and/or other device for receiving, sending, and/or presenting data. The network interface hardware 234 may include and/or be configured for communicating with any wired or wireless networking hardware, including an antenna, a modem, LAN port, wireless fidelity (Wi-Fi) card, WiMax card, mobile communications hardware, and/or other hardware for communicating with other networks and/or devices. From this connection, communication may be facilitated between the user computing device 102a and other computing devices.

The operating logic 242 may include an operating system and/or other software for managing components of the user computing device 102a. Similarly, as discussed above, the client development logic 144a may reside in the memory component 140 and may be configured to cause the processor 230 to determine viable options for future client development. As an example, the client development logic 144a may access data from other pieces of logic 144b-144h and utilize this data to determine which clients are able to provide additional work and in which areas of law. Similarly the client development logic 144a may also be utilized to determine a potential client that could supplement a law firm client roster. Other functionality is also included and described in more detail, below.

It should be understood that the components illustrated in FIG. 2 are merely exemplary and are not intended to limit the scope of this disclosure. While the components in FIG. 2 are illustrated as residing within the user computing device 102a, this is merely an example. In some embodiments, one or more of the components may reside external to the user computing device 102a. It should also be understood that, while the user computing device 102a in FIG. 2 is illustrated as a single device, this is also merely an example. In some embodiments, the client development logic 144a and/or the other pieces of logic 144b-144h may reside on one or more different devices.

Additionally, while the user computing device 102a is illustrated with the client development logic 144a, the client analysis logic 144b, the contacts logic 144c, the billing logic 144d, the GL logic 144e, the budget logic 144f, the HR logic 144g, and the spreadsheet logic 144h as separate logical components, this is also an example. In some embodiments, a single piece of logic may cause the user computing device 102a to provide the described functionality.

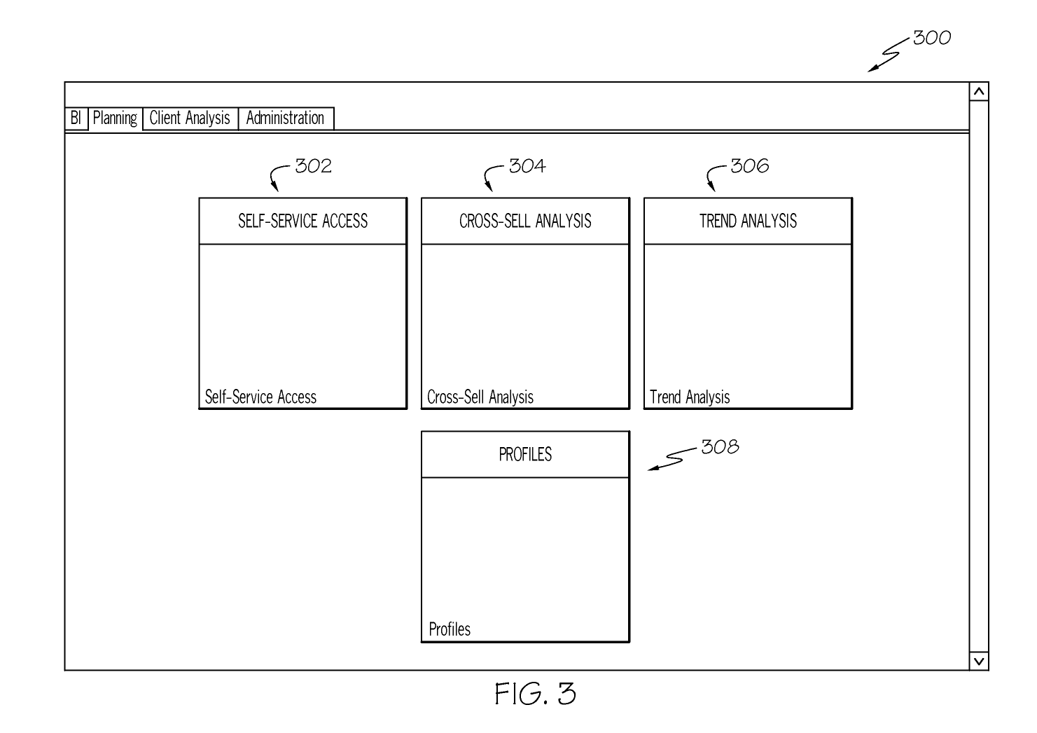

FIG. 3 depicts a user interface 300 for providing a plurality of client development applications, according to one or more embodiments shown and described herein. As illustrated, the user interface 300 provides a plurality of options such as a self-service access option 302, a cross-sell option 304, a trend analysis option 306, and a profiles option 308. As discussed in more detail, below the self-service access option 302 may cause the user computing device 102a to determine client-related billing information for a particular law firm. The cross-sell analysis option 304 can cause the user computing device 102a to determine cross-selling opportunities. The trend analysis option 306 can cause the user computing device 102a to determine various trends related to client billings. The profiles option 308 can cause the user computing device 102a to determine various client development strategies for increasing billings for existing clients and/or developing new clients.

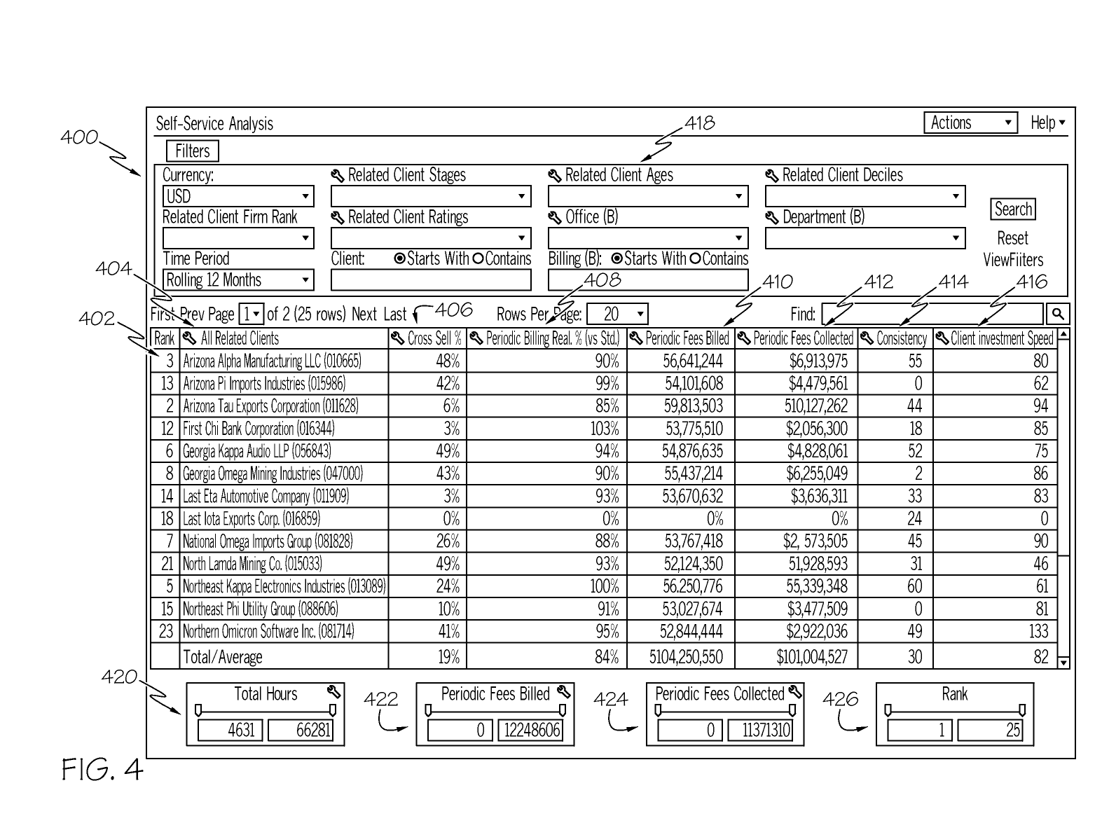

FIG. 4 depicts a user interface 400 for providing statistics on current clients of a firm, according on one or more embodiments shown and described herein. As illustrated, the user interface 400 includes a table of clients 402. The table of clients 402 may include all of the clients 404 for a particular law firm and may be ranked in terms of value to the law firm. Also included in the table of clients 402 are a cross-sell percentage 406, a periodic billing realization percentage 408, a periodic fees billed value 410, a periodic fees collected value 412, a consistency value 414, and a client investment speed value 416. Specifically, the cross-sell percentage 406 provides the user with a value representative of the diversification of work from a client across different areas of law. The periodic billing realization 406 represents a value of hours worked versus hours billed to the client. The periodic fees billed value 410 is representative of the dollar value of fees that were billed to the client over a predetermined amount of time. The periodic fees collected value 412 represents the dollar value of fees that have been collected from the client over the predetermined amount of time. The consistency value 414 represents a rating of the consistency that work has been received from the client over a predetermined period of time. The client investment speed value 416 represents the speed that work has increased from the client. One should note that while in some embodiments, the information provided by the categories 406-416 may be current values, in some embodiments, this information may be provided as data compiled over a predetermined amount of time.

Also included are filtering user options 418, which allow a user to filter the results. As illustrated the results may be filtered according to currency, rank, time period, stage, ratings, client name, client age, office, billing name, related client deciles, and department. Also included are filters for total hours 420, periodic fees billed value 422, periodic fees collected value 424, and rank 426.

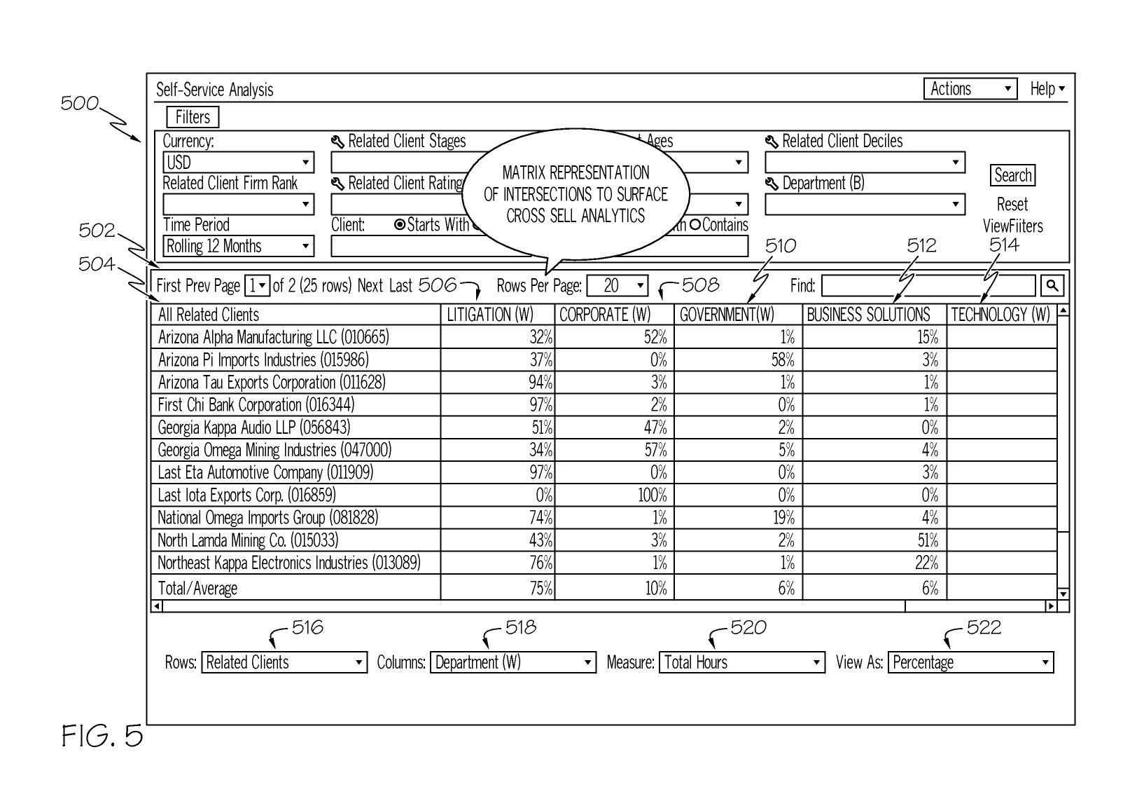

FIG. 5 depicts a user interface 500 for filtering client data by area of law, according on one or more embodiments shown and described herein. As illustrated, in response to selection of the cross-sell analysis option 304 (FIG. 3), the user interface 500 may be provided on the user computing device 102a. Similar to the user interface 400 (FIG. 4), the user interface 500 includes a table of clients 502. The table of clients 502 includes the clients 504, as well as columns for each of the areas of law from which a client may be cross sold. In the example of FIG. 5, the columns include a litigation column 506, a corporate column 508, a government column 510, a business solutions column 512, and a technology column 514. The values in each of these columns represent a percentage of work that the client provides in each of these areas of law. Totals may over all clients (and/or over all clients that conform to an applied filter) for providing firm wide data.

Also included are options for determining the entries in the table of clients 502. More specifically, a rows option 516 may cause the user interface 500 to provide different information for the rows (e.g., partners, areas of law, etc.). A columns option 518 allows for different types of cross-sell categories, aside from cross-selling by department (e.g., by partners, associates, time periods, technology, etc. The measure option 520 allows for the cross-sell data to be calculated based on total hours billed, total hours collected, total dollars billed, total dollars collected, and the like. The view as option 522 may provide options to view the cross-sell information as a percentage and/or other value.

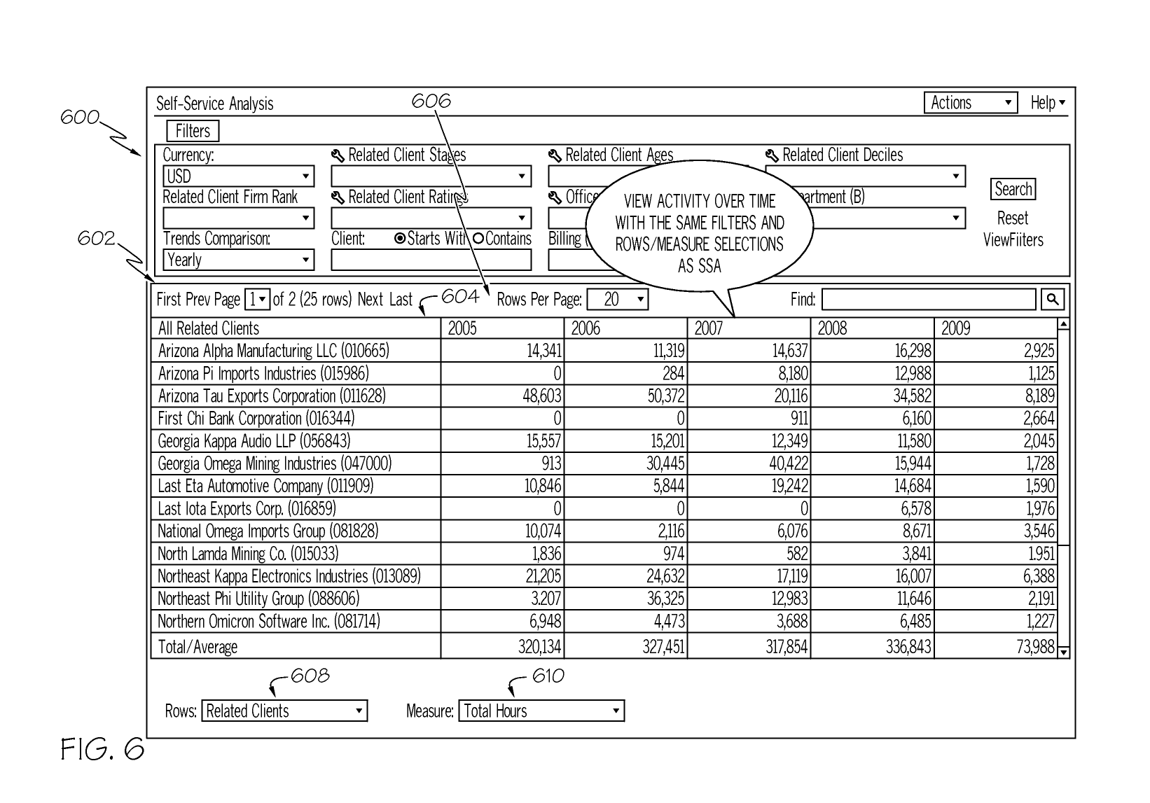

FIG. 6 depicts a user interface 600 for filtering client data organized by year, according on one or more embodiments shown and described herein. As illustrated, the user interface 600 may be provided in response to selection of the trend analysis option 306. More specifically, the user interface 600 may include a table of clients 602, which includes clients 604 and date columns 606. Accordingly, information can be provided on each of the listed clients according to year. In the example of FIG. 6, the total hours billed may be provided. Additionally included is a rows option 608 for changing the information provided in the rows of the table of clients 602. A measure option 610 for changing the type of data provided in the table of clients 602.

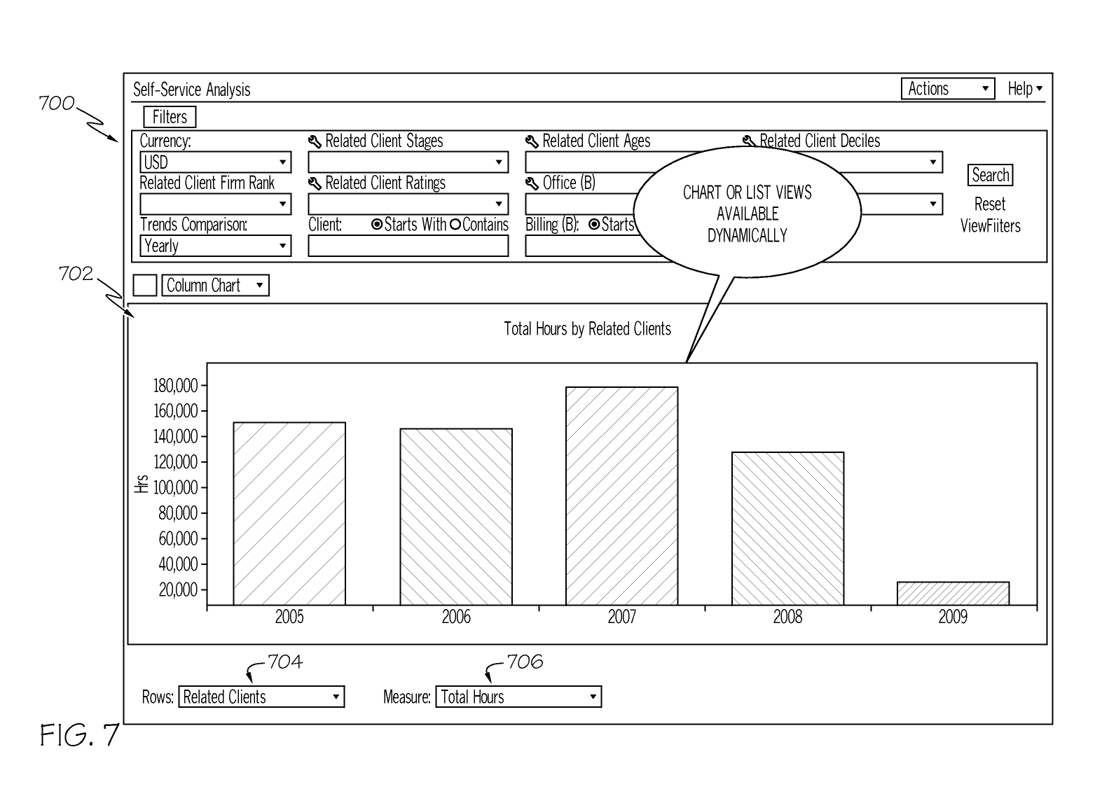

FIG. 7 depicts a user interface 700 for providing a chart of client hours organized by year, according on one or more embodiments shown and described herein. As illustrated, the information from FIG. 6 may be provided in graph form 702. Additionally provided are a rows option 704 to determine the data that is being graphed (in this example, all clients) and a measure option 706 to determine the criteria that is graphed.

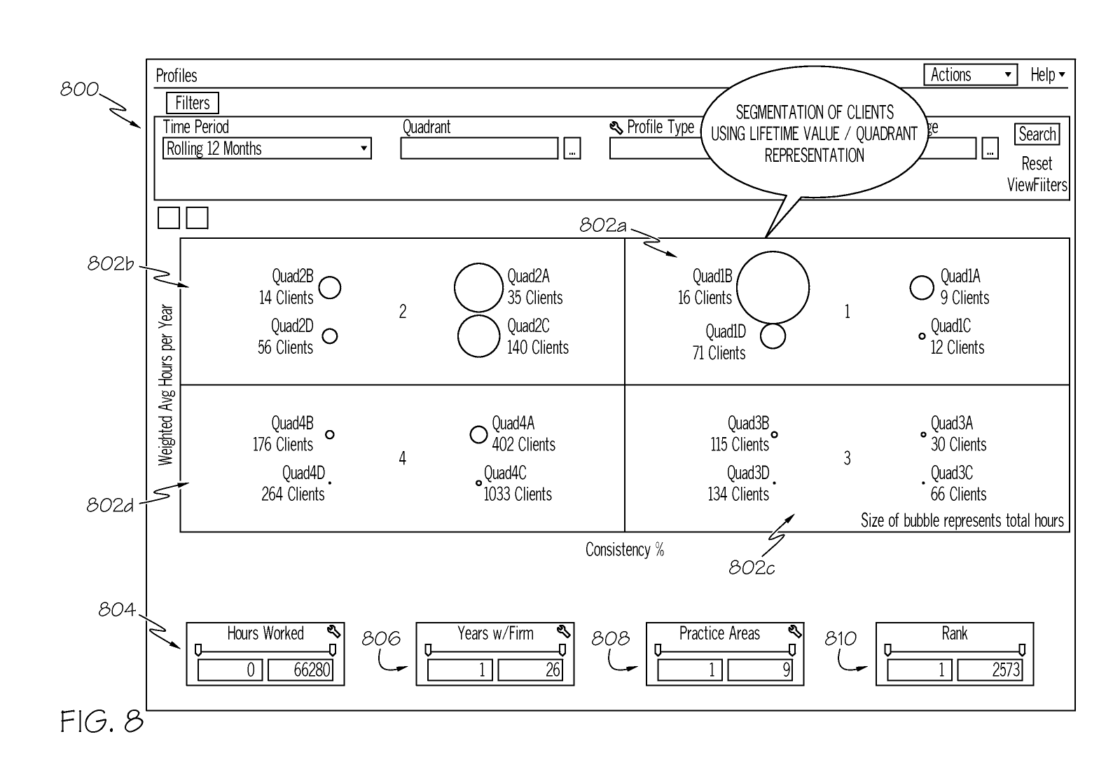

FIG. 8 depicts a user interface 800 for providing client classifications, according on one or more embodiments shown and described herein. As illustrated, the user interface 800 may be provided in response to selection of the profiles option 308 (FIG. 3). Additionally, the user interface 800 includes a first quadrant 802a, a second quadrant 802b, a third quadrant 802c, and a fourth quadrant 802d. When viewed as a two dimensional Cartesian graph, the y-axis may represent average hours worked per year, while the x-axis represents a consistency of work percentage. Accordingly, the first quadrant 802a includes icons for clients that provide the largest amount of work with the most consistency. The second quadrant 802b includes icons for clients that provide the largest amount of work with less consistency. The third quadrant 802c includes icons for clients that provide less work, but with greater consistency. The fourth quadrant 802d includes icons for clients that provide less work with less consistency.

Also included in FIG. 8 are filters for changing the user interface 800. More specifically, an hours worked filter 804 can limit the clients displayed to only those that provide hours within a selected range. A years with the firm filter 806 can limit the user interface 800 to only those clients that have been with the law firm for a selected range of years. A practice areas filter 808 can limit the user interface 800 to only clients that provide work in selected practice areas. A rank filter 810 can cause the user interface 800 to provide clients only within a selected rank range. A change view option 812 is also provided for changing the view of provided in the user interface 800. A report option 823 is provided to facilitate generating one or more reports of the client billing data. The reports may be user-configurable in that the user may apply filters to determine the data provided in the reports. If the user decides to change information provided in a report, the user can change the filters in the user interface 800 and select the report option 823 again.

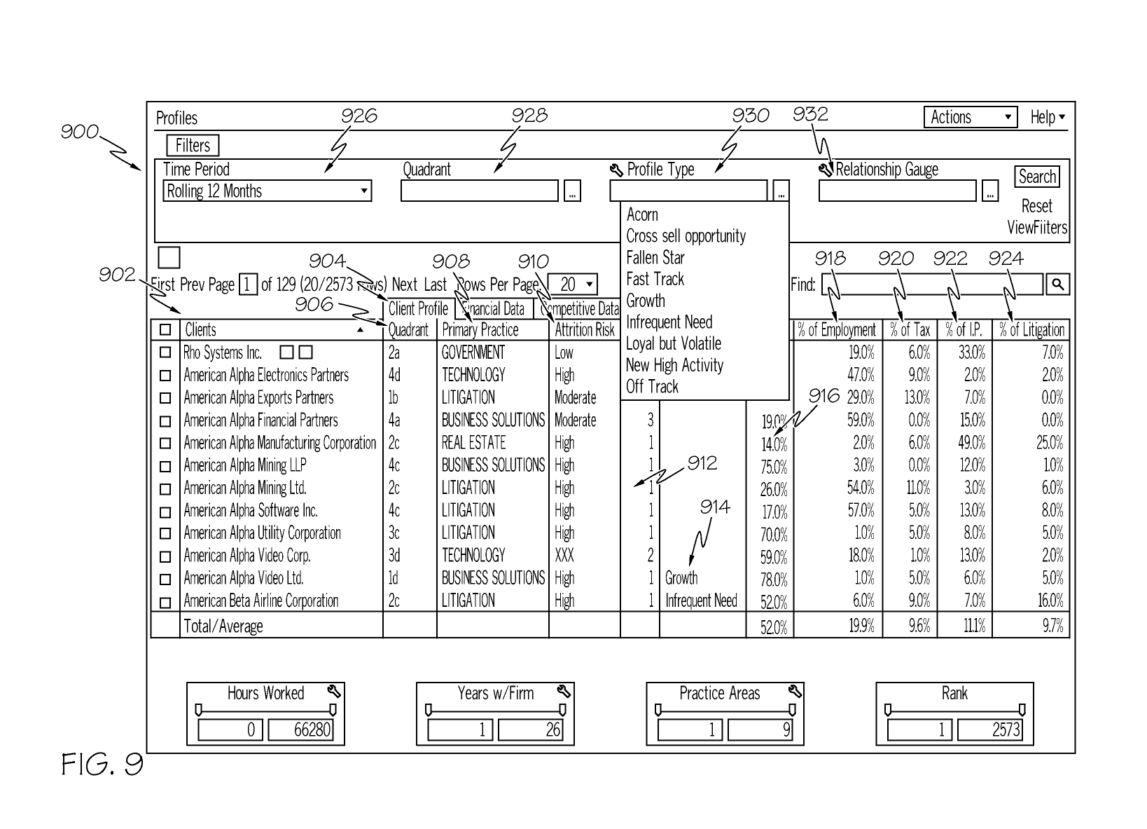

FIG. 9 depicts a user interface 900 for organizing clients by profile, according on one or more embodiments shown and described herein. As illustrated, the report provided in the user interface 900 may be provided in response to selection of the report option 812 (FIG. 8). The user interface 900 includes a table of clients 902 which includes a client roster and a client profile tab 904. Under the client profile tab 904 a plurality of fields, such as a quadrant column 906, a primary practice column 908, an attrition risk 910, a years with firm column 912, a profile type column 914, a percentage of corporate column 916, a percentage of employment column 918, a percentage of tax column 920, a percentage of intellectual property column 922, and a percentage of litigation column 924.

The quadrant column 906 may be configured to provide the quadrant from FIG. 8 that the client currently resided. The profile type column 914 provides a profile type that the user computing device 102a has determined as relating to that client. More specifically, the user computing device 102a can classify the client according to a predicted likelihood of future billings (and/or expanded billings). As an example, the client may be determined to be an acorn (with growth potential), a cross-sell opportunity, a fallen star (likely fading), a fast track (rapid growth possibility), growth , in frequent need, loyal but volatile, new high activity, and off track (likely lost). These classifications may be determined from the trend data, from cross-sell data, external data, etc. Additionally, the percentage of corporate column 916 may provide the percentage of total work from that client that is related to corporate law. Similarly, the percentage of employment column 918, the percentage of tax column 920, and the percentage of litigation column 924 relate to the fraction of total work related to those areas of law for a particular client. Also included are a time period filter 926, a quadrant filter 928, a profile type filter 930, a relationship filter 932, an hours worked filter 934, a years with firm filter 936, a practice areas filter 938, and a rank filter 940. As discussed above, these filters may restrict the results displayed in the table of clients 902 to the selected criteria. Additionally, other filters may be utilized in any of the reports and/or user interfaces, to provide filtering by time period, filtering by client classification, filtering by profile type, filtering by relationship gauge, hours worked, years as a client, filter by practice area, filter by client rank, filter by office, filter by attorney, filter by department, filter by currency, filter by cross sell percentage, filter by billing realization, filter by fees billed, filter by fees collected, filter by consistency, etc.

Also included is a report option 923 for generating one or more user-configurable reports. More specifically, upon selection of the report option 923, a report of the information in the user interface 900 may be generated. The report may be user configurable in that the filtering user options in the user interface 900 may also alter the information in the generated report. Additionally, as well other reports described herein, some embodiments of the reports generated by selection of the report option 923 may be dynamic in that as billing and/or other client data changes, the report may be automatically updated to reflect the change in information.

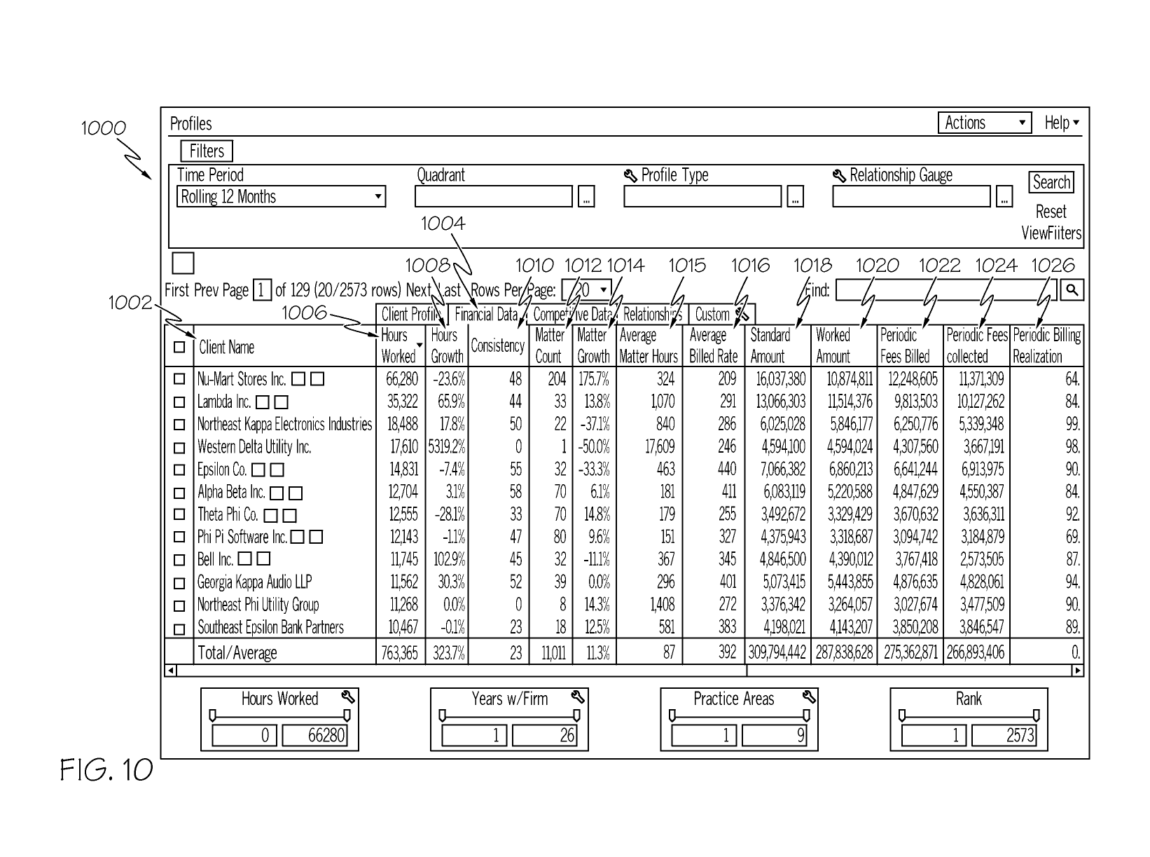

FIG. 10 depicts a user interface 1000 for providing financial metrics of clients, according on one or more embodiments shown and described herein. As illustrated, by selecting a financial data tab 1004 on a table of clients 1002, financial data may be provided. The financial data may be organized according to a plurality of fields, such as an hours worked column 1006, an hours growth column 1008, a consistency column 1010, a matter column 1012, a matter growth column 1014, an average matter hours column 1015, an average billed rate column 1016, a standard amount column 1018, a worked amount column 1020, a periodic fees billed column 1022, a periodic fees collected column 1024, and a periodic billing realization column 1026. Also included is a report option 1023 for providing a user-configurable report of at least a portion of the data from the user interface 1000.

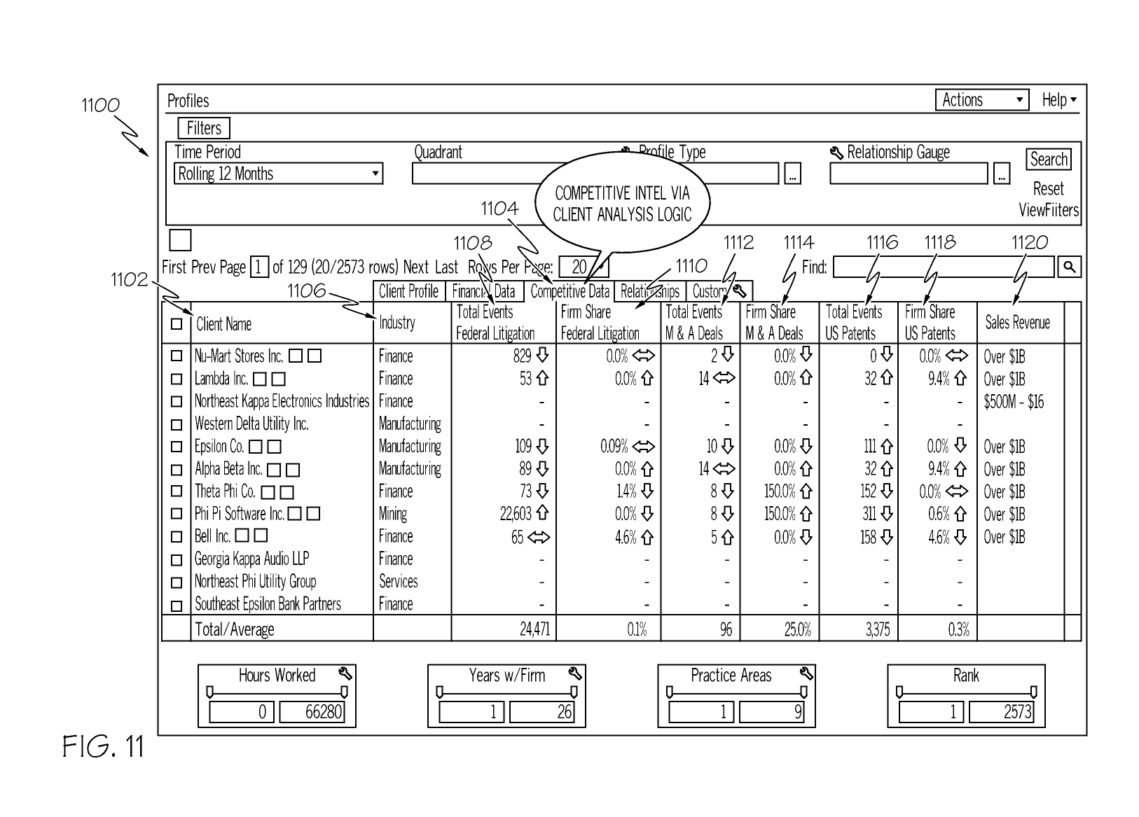

FIG. 11 depicts a user interface 1100 for providing competitive data about a plurality of clients in a user-configurable report, according on one or more embodiments shown and described herein. As illustrated, a table of clients 1102 may be provided in response to selection of a competitive data tab 1104. The table of clients 1102 includes a plurality of fields, such as an industry column 1106, a total events federal litigation column 1108, a firm share federal litigation column 1110, a total events M&A deals column 1112, a firm share M&A deals column 1114, a total events US patents column 1116, a firm share US patents column 1118, and a sales revenue column 1120.

The total events federal litigation column 1108 indicates the total number of federal litigations that a particular client has had over a predetermined amount of time. The firm share federal litigation indicates a change that the law firm has realized in market share of the federal litigations with that client. Similarly, the total events M&A deals column 1112 indicates the total number of mergers and acquisitions that a client has completed over the predetermined amount of time. The firm share M&A deals column 1114 indicates a change in the market share of that work that the law firm realized. The total events US Patent column 1116 indicates a total number of United States patents acquired by that client over a predetermined amount of time. The firm share of US patents column 1118 indicates the market share change of that work that the firm realized over the predetermined amount of time. The sales revenue column 1120 indicates the total sales revenue of that client over the predetermined amount of time. Additionally, a report option 1123 may be provided for generating one or more user-configurable reports, as described above.

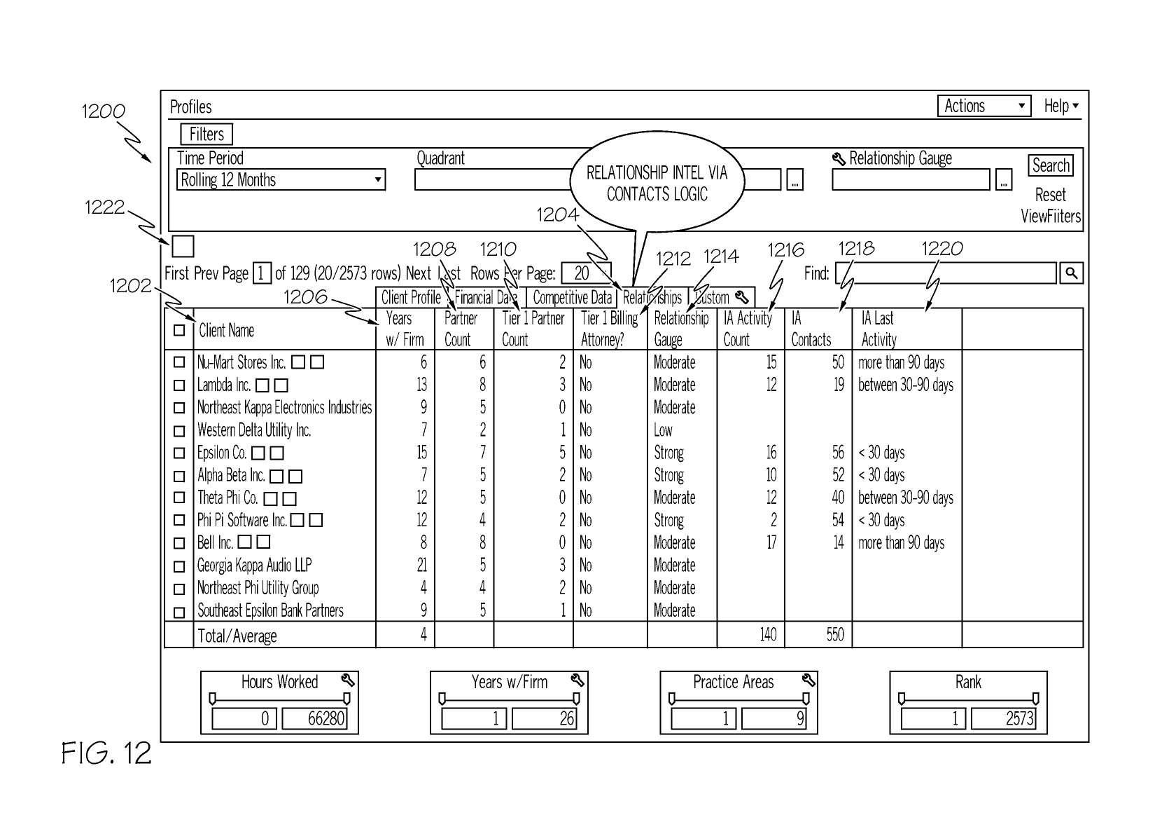

FIG. 12 depicts a user interface 1200 for providing relationship data about a plurality of clients in a user-configurable report, according on one or more embodiments shown and described herein. As illustrated, a table of clients 1202 may be provided in response to selection of the relationships tab 1202. As indicated in FIG. 12, the relationship data in the user interface 1200 may be accessed via the contacts logic 144c. More specifically, the table of clients 1204 includes a plurality of fields, such as a years with the firm column 1206, a partner count column 1208, a tier 1 partner count column 1210, a tier 1 billing attorney column 1212, a relationship gauge column 1214, an activity count column 1216, a contacts column 1218, and a last activity column 1220.

More specifically, the years with the firm column 1206 indicates how long a contact with the client has been listed in the contacts logic 144c. The partner count column 1208 indicates how many partners have a contact with the client. The tier 1 partner count column 1210 indicates how many tier 1 partners have a contact with the client. The tier 1 billing attorney column 1212 indices whether there is a tier 1 billing attorney that works with the client. The relationship gauge column 1214 provides a determination regarding whether, based on the information in the user interface 1200, there is a strong relationship with the client, a moderate relationship, or a low relationship. This may be determined from the information in the columns 1206-1212 and/or from other information, such as in FIGS. 4-11.

The activity count column 1216 may provide information on the number of activities that have been performed with a contact of the clients, as indicated by the contacts logic 144c. Similarly, the contacts column 1218 indicates the total number of contacts that the law firm has with the client. The last activity column 1220 indicates an amount of time since the last activity with the client has been performed. This may include billing entries, matter openings, engagement letters, emails, telephone calls and/or other activities. Also included in the user interface 1200 is an export option 1222. The export option 1222 may be configured as a link that provides access to the contacts logic 144c. A report option 1223 may also be provided for generating one or more user-configurable reports, similar to those described above.

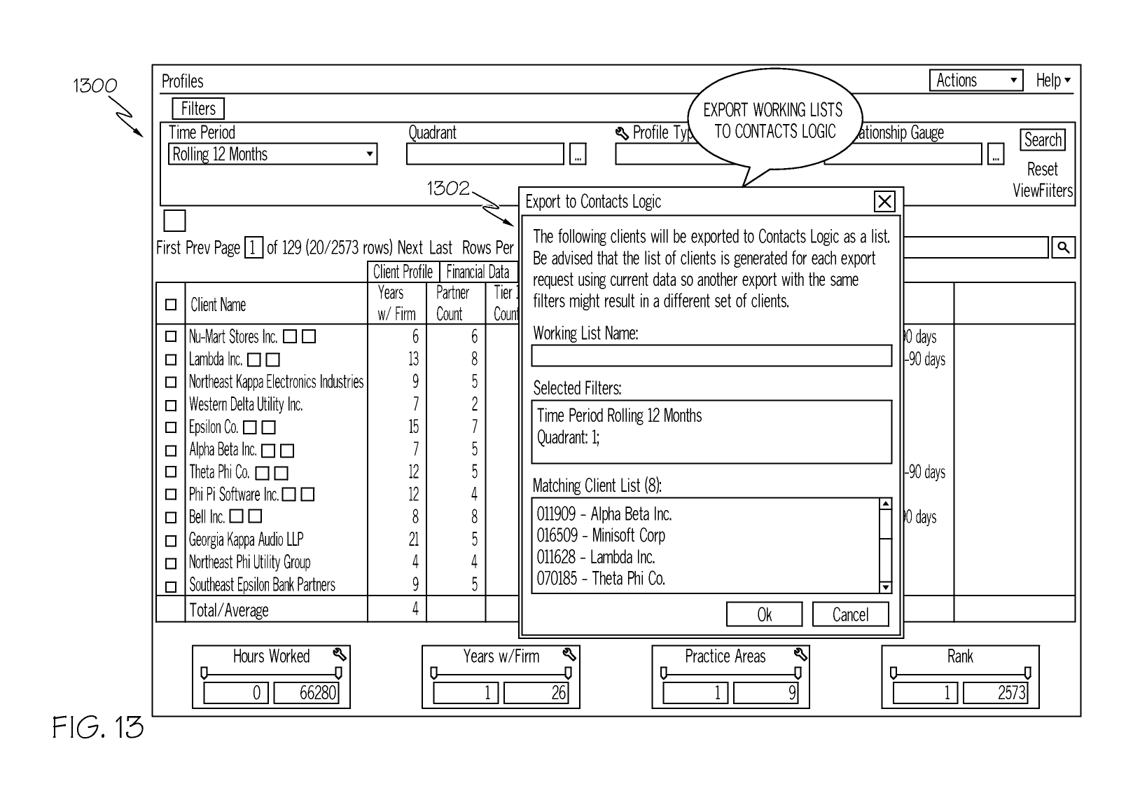

FIG. 13 depicts a user interface 1300 for providing exporting options of client data, according on one or more embodiments shown and described herein. As illustrated, the user interface 1300 may be accessed via selection of the export option 1222 and includes an export window 1302 that provides options for exporting data to the contacts logic 144c. As a consequence, the export window 1302 can facilitate updating of information in the contacts logic 144c.

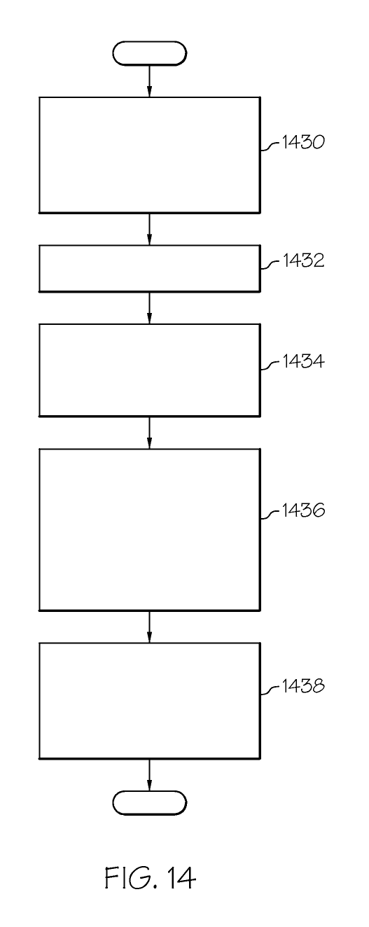

FIG. 14 depicts a process for determining potential expanded billing for a client, according to one or more embodiments shown and described herein. As illustrated in block 1430, client identification data may be received for a first client, where the client identification data is received from the client analysis logic 144b. At block 1432, client billing data for the first client may be received. At block 1434, a determination of billing trend data for the first client may be made from the client identification data and the client billing data. At block 1436, a client classification may be determined from the billing trend, where the client classification indicates a predicted likelihood of generating additional billings. At block 1438, a user interface may be provided for display, where the user interface includes an area for expanded billing for the client, based on the predicted likelihood of generating additional billings.

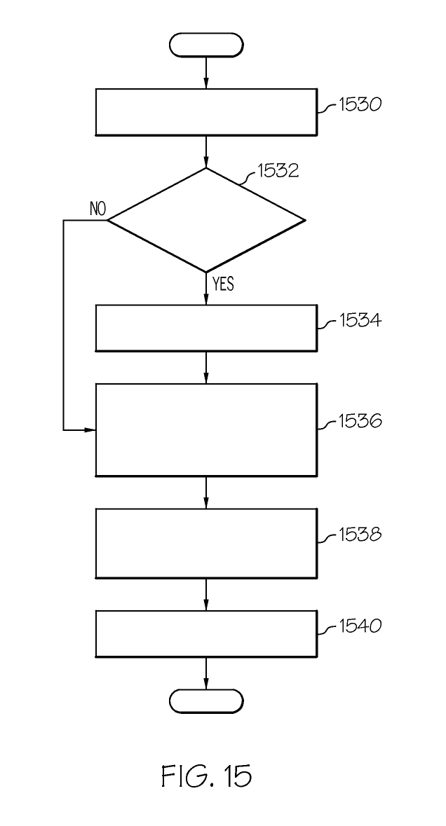

FIG. 15 depicts a process for determining a client development strategy, according to one or more embodiments shown and described herein. As illustrated in block 1530, client data may be retrieved from a firm network. At block 1532, a determination may be made regarding whether an analysis has been previously performed. If so, at block 1534 the previously performed analysis data may be accessed. At block 1536, (or if at block 1532, an analysis was not previously performed), an analysis may be performed on the retrieved data to categorize a previous client based on a client value and consistency. At block 1538, the analysis from the previous client may be compared to determine a client development strategy. At block 1540, an indication of a determined client development strategy may be provided.

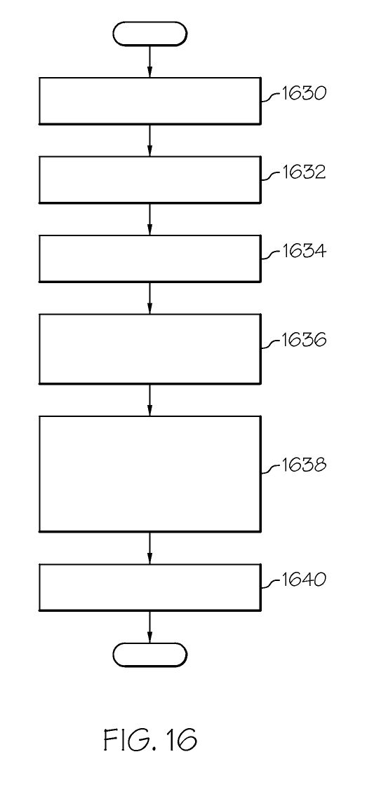

FIG. 16 depicts a process for determining a strategy for realizing client growth potential, according to one or more embodiments shown and described herein. At block 1630, client related data may be retrieved from the firm network. At block 1632, billing trend data may be determined from the client related data. The billing trend data may include a billing trend, a matter opening trend, and/or other trend over a predetermined amount of time. Similarly, in some embodiments, the billing trend data may include any data that is calculated from billing data received from the logic 144b-144h, such as a cross-sell percentage, a periodic billing realization percentage, a periodic fees billed value, a periodic fees collected value, a consistency figure, and an attrition risk. At block 1634, a client may be classified based on the trend. At block 1636, a determination regarding whether the client has potential growth potential may be made from the trend data and the client classification. At block 1638, in response to determining that the client has growth potential, a strategy for realizing the growth potential may be determined. At block 1640, the strategy may be provided to the user.

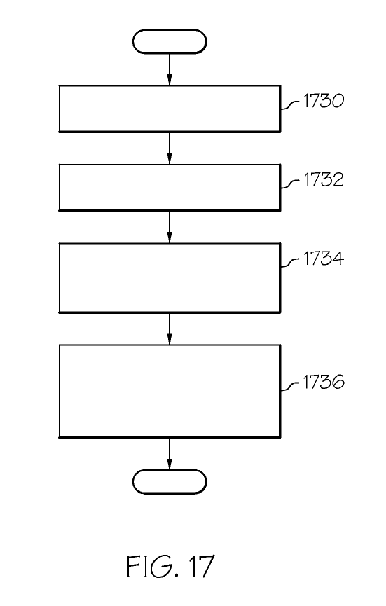

FIG. 17 depicts a process for determining a client deficiency (such as a billing deficiency), according to one or more embodiments shown and described herein. More specifically at block 1730, client related data may be retrieved from the firm network. At block 1732, a determination of at least one trend may be made form the client related data. At block 1734, a determination regarding whether recent client activity has been less than the determined trend would indicate. At block 1736, in response to determining that the recent client activity is less than the trend would indicate, an indication of this deficiency may be provided.

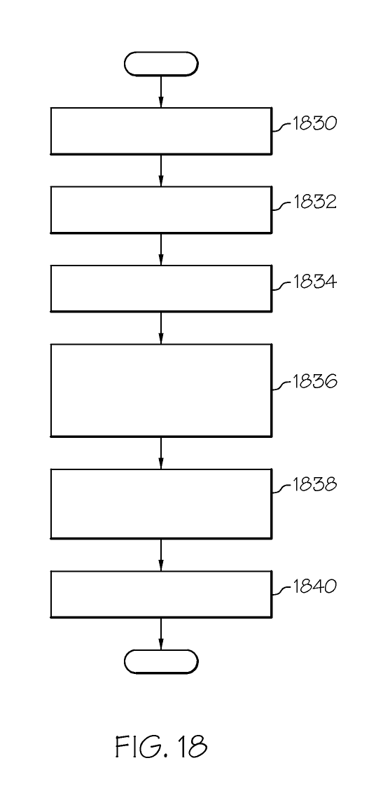

FIG. 18 depicts a process for determining a potential client to fill a firm deficiency, according to one or more embodiments shown and described herein. More specifically, at block 1830, data may be retrieved from the firm network. At block 1832, a determination may be made from the retrieved data regarding a client deficiency. At block 1834, potential client data may be retrieved, such as from an external source. At block 1836, a potential client that could correct the client deficiency may be determined from the potential client data and/or other data. In some embodiments, a predicted likelihood of acquiring billings from the potential client may also be determined. At block 1838, a firm representative for contacting the potential client may be determined. At block 1840, the data may be provided for display, such as in a user interface.

Additionally, in some embodiments, a potential client classification may be determined, where the potential client classification indicates a predicted likelihood of acquiring billings from the potential client. Such a determination may be similar to the determination of existing clients, as described with regard to FIG. 8, and/or similar to the determination of the profile types as described with regard to FIG. 9. In some embodiments a potential client trend may be determined. More specifically, as data is compiled regarding a potential client, the user computing device 102a (FIGS. 1 and 2) and/or the remote computing device 102b (also FIGS. 1 and 2) can store data from previous searches. The user computing device 102a and/or the remote computing device 102b can then determine the potential client trend data from recently retrieved data, as well as from the stored data. In some embodiments, the historical data may simply be retrieved with the current data.

As will be understood, since the potential clients are not yet actual clients, access to the potential client data may be limited to public records. As such, embodiments disclosed herein may be configured to access predetermined data sources, such as government websites, company websites, etc. to locate the desired information about the potential client. In some embodiments, access to private records may available and utilized by the user computing device 102a and/or the remote computing device 102b.

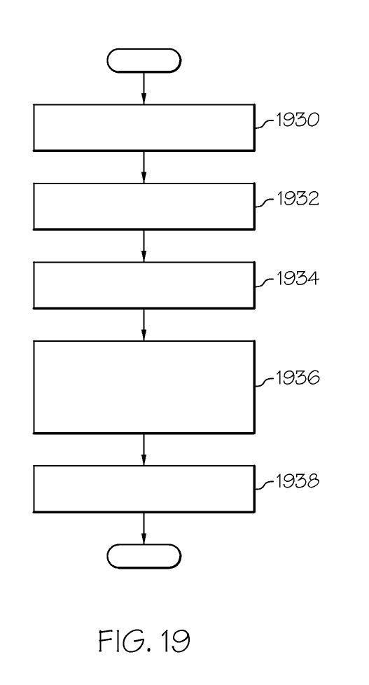

FIG. 19 depicts a process for determining an area that a client could fill a firm deficiency, according to one or more embodiments shown and described herein. As illustrated at block 1930, data may be retrieved from the firm network. At block 1932, a client deficiency may be determined from the retrieved data. At block 1934, client data may be retrieved from an external source. At block 1936, a potential solution, such as an area that the client may provide additional work may be determined from the client data. In some embodiments a predicted likelihood of generating additional billings from the client may also be determined. At block 1938, the data may be provided for display.

As discussed above, embodiments disclosed herein include systems and methods for client development. The embodiments may be configured to predict client trends for determining where a law firm has an opportunity for additional work. This might include predicting a current client that can fulfill this law firm deficiency and/or a prospective client that may be able to fulfill this work. Similarly, in some embodiments, the systems and methods may be configured to determine the types of work that a client (or potential client) can provide by accessing publicly accessible data and comparing that data with client billing (and other) data. Similarly, embodiments disclosed herein also provide a user interface that may be user-configurable to provide billing data in a dynamic manner. The user can change the data provided and/or filter the data. Similarly, reports may be generated, which may also be user-configurable such that the data provided therein is also dynamic. This allows a user to customize the data provided to more accurately assess current and future client development strategies.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for client development comprising:
a memory component that stores client analysis logic and client development logic, the client development logic causing the system to perform at least the following:
receive a client roster for an entity, the client roster comprising a plurality of clients;
receive client billing data for the plurality of clients;
compute billing trend data for the plurality of clients;
generate a user interface for display that provides the billing trend data according to a plurality of fields, the user interface comprising a filtering user option to alter the user interface by filtering at least one of the plurality of fields, the user interface further comprising a report option to generate a report that comprises at least a portion of the billing trend data;
generate the report in response to selection of the report option; and
alter the report in response to selection of the filtering user option.

2. The system of claim 1, wherein the memory component further stores contacts logic, the client development logic further causing the system to interact with the contacts logic to perform the following:
determine a potential client;
determine a potential client classification for the potential client, the potential client classification indicating a predicted likelihood of acquiring billings from the potential client; and
provide the potential client classification in the user interface.

3. The system of claim 1, wherein the billing trend data comprises at least the following: a cross-sell percentage, a periodic billing realization percentage, a periodic fees billed value, a periodic fees collected value, a consistency figure, and an attrition risk.

4. The system of claim 1, wherein the client roster and the client billing data are automatically received at predetermined times.

5. The system of claim 1, wherein the client development logic further causes the system to determine, from the client billing data, a billing deficiency in one of the plurality of clients and determine a potential solution for overcoming the billing deficiency.

6. The system of claim 1, wherein the client development logic further causes the system to update information managed by the contacts logic.

7. The system of claim 1, wherein filtering at least one of the plurality of fields comprises at least one of the following: filtering by time period, filtering by client classification, filtering by profile type, filtering by relationship gauge, hours worked, years as a client, filter by practice area, filter by client rank, filter by office, filter by attorney, filter by department, filter by currency, filter by cross sell percentage, filter by billing realization, filter by fees billed, filter by fees collected, and filter by consistency.

8. A method for client development comprising:
receiving client identification data for a client, the client identification data being received from client analysis logic;
receiving client billing data for the client;
determining, from the client identification data and the client billing data, billing trend data for the client;
predicting, from the billing trend data, a likelihood of expanded billing for the client; and
providing, by a computing device, a first user interface for display, the first user interface providing at least a portion of the billing trend data and data related to the likelihood of expanded billing for the client, the first user interface further providing a filtering user option to filter at least a portion of the billing trend data from the first user interface.

9. The method of claim 8, further comprising:
determining a potential client;
determining a potential client classification for the potential client, the potential client classification indicating a predicted likelihood of acquiring billings from the potential client; and
providing the potential client classification in a second user interface.

10. The method of claim 8, wherein the billing trend data comprises at least the following: a cross-sell percentage, a periodic billing realization percentage, a periodic fees billed value, a periodic fees collected value, a consistency figure, and an attrition risk.

11. The method of claim 8, wherein filtering at least a portion of the billing trend data comprises at least one of the following: filtering by time period, filtering by client classification, filtering by profile type, filtering by relationship gauge, hours worked, years as a client, filter by practice area, filter by client rank, filter by office, filter by attorney, filter by department, filter by currency, filter by cross sell percentage, filter by billing realization, filter by fees billed, filter by fees collected, and filter by consistency.

12. The method of claim 8, further comprising determining, from the client billing data, a deficiency in the client and determining a potential solution for overcoming the deficiency.

13. The method of claim 8, further comprising updating information managed by the client analysis logic.

14. The method of claim 8, further comprising generating a user-configurable report from at least a portion of the billing trend data, wherein selection of the filtering user option further causes a change to the user-configurable report.

15. A non-transitory computer-readable medium for client development that stores client development logic that causes a computer to interact with client analysis logic and contacts logic to perform at least the following:
receive client identification data for a client, the client identification data being received from the client analysis logic;
receive client billing data for the client;
determine, from the client identification data and the client billing data, billing trend data for the client;
determine a potential client trend for a potential client;
determine, from the potential client trend, whether the potential client can overcome a deficiency in the client; and
provide a user interface for display, the user interface comprising data related to whether the potential client can overcome the deficiency in the client, the user interface including providing a report option to generate a user-configurable report that comprises at least a portion of the client billing data, the user interface providing a filtering user option to at least a portion of the user-configurable report.

16. The non-transitory computer-readable medium of claim 15, wherein the billing trend data comprises at least the following: a cross-sell percentage, a periodic billing realization percentage, a periodic fees billed value, a periodic fees collected value, a consistency figure, and an attrition risk.

17. The non-transitory computer-readable medium of claim 15, wherein the client identification data and the client billing data are automatically received at predetermined times.

18. The non-transitory computer-readable medium of claim 15, wherein the client development logic further causes the computer to determine, from the client billing data, a billing deficiency in the client and determine a potential solution for overcoming the billing deficiency.

19. The non-transitory computer-readable medium of claim 15, wherein the client development logic further causes the computer to update information managed by the client analysis logic.

20. The non-transitory computer-readable medium of claim 15, wherein the client development logic further causes the computer to determine a rank for the client according to amount of work and consistency and wherein the client development logic further causes the computer to graphically provide the rank in the user interface.
